(19) United States
(12) Patent Application Publication
(10) Pub. No.: US 2013/0099150 A1
(43) Pub. Date: Apr. 25, 2013

(54) R-T-B-BASED RARE EARTH PERMANENT MAGNET, MOTOR, AUTOMOBILE, POWER GENERATOR, AND WIND POWER-GENERATING APPARATUS

(71) Applicants: Kenichiro Nakajima, Chichibu-shi (JP); Takashi Yamazaki, Chichibu-shi (JP)

(72) Inventors: Kenichiro Nakajima, Chichibu-shi (JP); Takashi Yamazaki, Chichibu-shi (JP)

(73) Assignee: SHOWA DENKO K.K., Minato-ku, Tokyo (JP)

(21) Appl. No.: 13/807,228

(22) PCT Filed: May 19, 2011
(86) PCT No.: PCT/JP2011/061537

§ 371 Date: Dec. 27, 2012

(30) Foreign Application Priority Data
Jun. 29, 2010 (JP) 2010-147580

(51) Int. Cl. H01F 1/01

(52) U.S. Cl. CPC H01F 1/01
USPC 252/62.51 R

(57) ABSTRACT

An R-T-B-based rare earth permanent magnet including a sintered body which is provided with a main phase mainly containing R₂Fe₁₄B, and with a grain boundary phase which has a greater R content than said main phase, wherein R denotes a rare earth element including Nd and Dy as an essential element, and the grain boundary phase includes a first grain boundary phase and a second grain boundary phase which have different atomic concentration of Dy to each other.

### TECHNICAL FIELD

The present invention relates to an R-T-B-based rare earth permanent magnet, a motor, an automobile, a power generator, and a wind power-generating apparatus, in particular, to an R-T-B-based rare earth permanent magnet that has a superior magnetic characteristic and is suitably used for a motor or a power generator, and to a motor, an automobile, a power generator, and a wind power-generating apparatus that use this R-T-B-based rare earth permanent magnet.

Priority is claimed on Japanese Patent Application No. 2010-147580, filed Jun. 29, 2010, the content of which is incorporated herein by reference.

### BACKGROUND ART

Conventionally, R-T-B-based rare earth permanent magnets are used in various types of motors, power generators or the like. In recent years, since demand for improving the heat tolerance of R-T-B-based rare earth permanent magnets has increased and also demand for energy conservation thereof has increased, the proportion of motor applications including applications in automobiles has increased.

An R-T-B-based rare earth permanent magnet contains Nd, Fe, and B serving as its primary component. R in an R-T-B-based magnet alloy is where a part of Nd has been substituted with another rare earth element such as Pr, Dy, and Tb. T is where a part of Fe has been substituted with another transition metal such as Co and Ni. B denotes boron.

As a material to be used for an R—Fe—B-based rare earth permanent magnet, there has been proposed one where in an R—Fe—B-based magnet alloy in which the presence volume ratio of R₂Fe₁₄B phase (where R denotes at least one type of a rare earth element), which is the primary phase component thereof, is 87.5 to 97.5% and the presence volume ratio of an oxide of a rare earth or a rare earth and a transitional metal is 0.1 to 3%, a compound with an average particle diameter of 5 μm or less, which is selected as a primary component in the metallic structure of the alloy from a ZrB compound composed of Zr and B, an NbB compound composed of Nb and B, and an HfB compound composed of Hf and B, disperses uniformly at maximum intervals of 50 μm or less in the adjacent compounds present in the alloy selected from the ZrB compound, the NbB compound, and the HfB compound (for example, refer to Patent Document 1).

Moreover, as a material to be used for an R—Fe—B-based rare earth permanent magnet, there has also been proposed one where in an R—Fe—Co—B—Al—Cu (where R denotes one or more types among Nd, Pr, Dy, Tb, and Ho, containing 15 to 33% by mass of Nd)-based rare earth permanent magnet material, at least two types from M-B—Cu-based compounds and M-C-based compounds (M denotes one or more types among Ti, Zr, and Hf) and, further, an R oxide are deposited in the alloy structure thereof (for example, refer to Patent Document 2).

### DOCUMENTS OF RELATED ART

### Patent Documents

[Patent Document 1] Japanese Patent Publication No. 3951099
[Patent Document 2] Japanese Patent Publication No. 3891307

### SUMMARY OF THE INVENTION

### Problems to be Solved by the Invention

However, in recent years, there has been a demand for R-T-B-based rare earth permanent magnets of even higher performance, and a further improvement is required in the magnetic properties such as coercivity of R-T-B-based rare earth permanent magnets. Particularly in a motor, there is a problem such that a current is generated inside the motor during rotation and the motor per se reaches a high temperature as a result of heat generation, and thus a magnetic force decreases leading to a decrease in efficiency. In order to overcome this problem, a rare earth permanent magnet having a high coercivity at room temperature is required.

As a method of enhancing the coercivity of the R-T-B-based rare earth permanent magnet, a method of increasing the Dy concentration in an R-T-B-based alloy is considered. As the Dy concentration in the R-T-B-based alloy is increased, a rare earth permanent magnet having a high coercivity (Hcj) can be obtained after sintering. However, when the Dy concentration in the R-T-B-based alloy is increased, remanence (Br) decreases.

Therefore, it was difficult to sufficiently enhance magnetic properties such as a coercivity of the R-T-B type rare earth permanent magnet in the prior art.

The present invention takes into consideration the above circumstances with an object of providing an R-T-B-based rare earth permanent magnet in which a high level of coercivity (Hcj) and excellent magnetic properties can be obtained without increasing the Dy concentration in the R-T-B-based alloy.

Moreover, an object of the present invention is to also provide a motor, an automobile, a power generator, and a wind power-generating apparatus that uses the above R-T-B-based rare earth permanent magnet having excellent magnetic properties.

### Means of Solving the Problems

The present inventors investigated the relationship between the Dy concentration of the grain boundary phase contained in an R-T-B-based rare earth permanent magnet, and the magnetic properties of the R-T-B-based rare earth permanent magnet. The present inventors have discovered that a sufficiently high level of coercivity (Hcj) can be obtained without increasing the Dy concentration by an R-T-B-based rare earth permanent magnet in which a grain boundary phase includes a first grain boundary phase and a second grain boundary phase wherein the Dy concentration of first grain boundary phase is different from that of the second grain boundary phase, as compared to an R-T-B-based rare earth permanent magnet containing a single grain boundary phase having the same Dy concentration.

It is presumed that the following contribute to these effects. That is, when a grain boundary phase includes two types of grain boundary phase having a different Dy concentration to each other, a grain boundary phase having a high concentration of Dy exhibits strong resistance to a reverse of magnetic domain. As a result, a coercive force thereof is improved. Further, inside of a main phase being in contact with the grain boundary phase having the high Dy concentration, Dy is concentrated near a phase boundary of the main phase to the grain boundary phase. Accordingly, since strong resistance to a reverse of magnetic domain is exhibited, a coercive force thereof is improved.

That is to say, the present invention is to provide each of the following aspects of the invention.

(1) An R-T-B-based rare earth permanent magnet including a sintered body which is provided with a main phase mainly containing R₂Fe₁₄B, and with a grain boundary phase which has a greater R content than said main phase, wherein R denotes a rare earth element including Nd and Dy as an essential element, and the grain boundary phase includes a first grain boundary phase and a second grain boundary phase which have different atomic concentration of Dy to each other.
(2) The R-T-B-based rare earth permanent magnet according to (1), wherein the Dy atomic concentration of the first grain boundary phase is less than that of the main phase, and the Dy atomic concentration of the second grain boundary phase is more than that of the main phase.
(3) The R-T-B-based rare earth permanent magnet according to (2), wherein the Dy atomic concentration of the second grain boundary phase is 1.5 to 3 times that of the main phase.
(4) The R-T-B-based rare earth permanent magnet according to (2) or (3), wherein the Dy atomic concentration of the second grain boundary phase is two to six times that of the first grain boundary phase.
(5) The R-T-B-based rare earth permanent magnet according to any one of (2) to (4), wherein the second grain boundary phase has the Dy atomic concentration of 2 to 9 at %.
(6) The R-T-B-based rare earth permanent magnet according to any one of (2) to (5), wherein the combined total of atomic concentration of rare earth elements contained in the second grain boundary phase is less than that in the first grain boundary phase.
(7) The R-T-B-based rare earth permanent magnet according to any one of (2) to (6), wherein the combined total of atomic concentration of rare earth elements contained in the second grain boundary phase is 30 to 40 at %.
(8) The R-T-B-based rare earth permanent magnet according to any one of (2) to (7), wherein an oxygen atomic concentration of the second grain boundary phase is higher than that of the main phase or that of the first grain boundary phase.
(9) The R-T-B-based rare earth permanent magnet according to any one of (2) to (8), wherein the oxygen atomic concentration of the second grain boundary phase is 1.3 to 1.5 times the combined total of atomic concentration of rare earth element.
(10) A motor provided with the R-T-B-based rare earth permanent magnet according to any one of (1) to (9).
(11) An automobile provided with the motor according to (10).
(12) A power generator provided with the R-T-B-based rare earth permanent magnet according to any one of (1) to (9).
(13) A wind power-generating apparatus provided with the power generator according to (12).

### Effect of the Invention

An R-T-B-based rare earth permanent magnet of the present invention includes a sintered body which is provided with a main phase mainly containing R₂Fe₁₄B, and with a grain boundary phase which has a greater R content than said main phase, wherein R denotes a rare earth element including Nd and Dy as an essential element, and the grain boundary phase includes a first grain boundary phase and a second grain boundary phase which have different atomic concentration of Dy to each other. Therefore, the R-T-B-based rare earth permanent magnet of the present invention can possess the grain boundary phase having high effects of improving magnetic properties, as compared to a grain boundary phase of an R-T-B-based rare earth permanent magnet containing a single grain boundary phase having the same concentration of Dy in the R-T-B-based rare earth permanent magnet.

Accordingly, it is possible to obtain a sufficiently high level of coercivity (Hcj) without increasing the Dy concentration, as compared to an R-T-B-based rare earth permanent magnet containing a single grain boundary phase having the same Dy concentration. Furthermore, it is possible to suppress the deterioration of magnetic properties such as remanence (Br) due to the addition of Dy. Thus, it is possible to realize an R-T-B-based rare earth permanent magnet having excellent magnetic properties, which is suitably used for a motor, an automobile, a power generator, a wind power-generating apparatus, or the like.

### BRIEF DESCRIPTION OF THE DRAWINGS

FIG. 1 is a micrograph of an example of an R-T-B-based rare earth permanent magnet according to the present invention, and is also a micrograph of an R-T-B-based rare earth permanent magnet of Experimental Example 3.

FIG. 2 is a micrograph of a micrograph of an R-T-B-based rare earth permanent magnet of Experimental Example 1, which is an example of an R-T-B-based rare earth permanent magnet according to the present invention.

### MODE FOR CARRYING OUT THE INVENTION

Hereunder, an embodiment of the present invention is described in detail.

In an R-T-B-based rare earth permanent magnet (hereunder, abbreviated and referred to as “R-T-B-based magnet”) of the present invention, R denotes a rare earth element including Nd and Dy as an essential element, T denotes a metal which essentially has Fe, and B denotes boron.

The R-T-B-based magnet of the present invention includes a sintered body which is provided with a main phase mainly containing R₂Fe₁₄B, and with a grain boundary phase which has a greater R content than said main phase. R denotes a rare earth element including Nd and Dy as an essential element.

The grain boundary phase constituting the R-T-B-based magnet of the present invention includes a first grain boundary phase and a second grain boundary phase which have different atomic concentration of Dy to each other.

In the present embodiment, a description will be given about the Dy atomic concentration of the second grain boundary phase being more than that of the first grain boundary phase.

In the R-T-B-based magnet of the present embodiment, it is preferable that the Dy atomic concentration of the first grain boundary phase be less than that of the main phase, and the Dy atomic concentration of the second grain boundary phase be more than that of the main phase. That is, the order of the Dy atomic concentration is expressed as follows: the first grain boundary phase<the main phase<the second grain boundary phase.

Generally, in an R-T-B-based magnet containing a single grain boundary phase having the same atomic concentration of Dy, the Dy concentration within the grain boundary phase is less than that of the main phase (the grain boundary phase<the main phase). Further, the Dy concentration within the grain boundary phase is defined, depending on the Dy concentration within the magnet. Furthermore, the higher the Dy concentration within the grain boundary phase is, the higher the effects of improving coercivity (Hcj) of the R-T-B-based magnet.

Conversely, in the R-T-B-based magnet of the present embodiment, the Dy atomic concentration of the second grain boundary phase contained in the grain boundary phase is more than that of the main phase. That is, in the present embodiment, the grain boundary phase is configured to contain the second grain boundary phase having a high atomic concentration of Dy to have high effects of improving coercivity (Hcj) of the R-T-B-based magnet, as compared to a grain boundary phase of an R-T-B-based magnet containing a single grain boundary phase having the same concentration of Dy in the R-T-B-based magnet. In this manner, even when the Dy concentration within the magnet is low, the R-T-B-based magnet of the present embodiment can obtain a sufficiently high level of coercivity (Hcj).

Further, the Dy atomic concentration of the second grain boundary phase is preferably 1.5 to 3 times that of the main phase. Furthermore, the Dy atomic concentration of the second grain boundary phase is preferably 2 to 6 times that of the first grain boundary phase.

Either when the Dy atomic concentration of the second grain boundary phase in comparison with that of the main phase is within the above-mentioned range, or when the Dy atomic concentration of the second grain boundary phase in comparison with that of the first grain boundary phase is within the above-mentioned range, the second grain boundary phase exhibits very excellent effects of improving coercivity (Hcj) of the R-T-B-based magnet. Therefore, an enhanced-high level of coercivity (Hcj) can be obtained.

Further, the second grain boundary phase preferably has the Dy atomic concentration of 2 to 9 at %. When the Dy atomic concentration of the second grain boundary phase is within the above-mentioned range, the second grain boundary phase exhibits very excellent effects of improving coercivity (Hcj) of the R-T-B-based magnet. Therefore, an enhanced-high level of coercivity (Hcj) can be obtained. When the Dy atomic concentration of the second grain boundary phase is less than the above-mentioned range, there is a concern that effects of improving coercivity of the R-T-B-based magnet due to the second grain boundary phase can not be sufficiently obtained. On the other hand, when the Dy atomic concentration of the second grain boundary phase is more than the above-mentioned range, remanence (Br) is reduced. As a result, there is a concern that remanence (Br) become inadequate.

Further, an oxygen atomic concentration of the second grain boundary phase is preferably higher than that of the main phase or that of the first grain boundary phase. It is presumed as follows. Rare earth elements contained in the second grain boundary phase are present in the state of an oxide thereof such as R₂O₃ within the second grain boundary phase. The second grain boundary phase is formed by oxidizing the rare earth elements. Since Dy is readily oxidized as compared to Nd, the atomic concentration of Dy is increased. As a result, the atomic concentration of Dy contained in the second grain boundary phase becomes sufficiently higher than that of the main phase or that of the first grain boundary phase. Therefore, the second grain boundary phase has very high effects of improving coercivity (Hcj) of the R-T-B-based magnet to obtain an enhanced-high level of coercivity (Hcj).

The oxygen atomic concentration of the second grain boundary phase may specifically be 1 to 1.5 times the combined total of atomic concentration of rare earth elements, and preferably 1.3 to 1.5 times. Further, the oxygen atomic concentration of the second grain boundary phase is preferably 40 to 50 at %. Either when the oxygen atomic concentration of the second grain boundary phase is 1 to 1.5 times the combined total of atomic concentration of rare earth elements, or when the oxygen atomic concentration of the second grain boundary phase is 40 to 50 at %, the atomic concentration of Dy contained in the second grain boundary phase can be sufficiently ensured. As a result, the second grain boundary phase has very high effects of improving coercivity (Hcj) of the R-T-B-based magnet. Therefore, it is presumed that an enhanced-high level of coercivity (Hcj) can be obtained.

When the oxygen atomic concentration of the second grain boundary phase based on the combined total of atomic concentration of rare earth elements is less than the above-mentioned range, the atomic concentration of Dy contained in the second grain boundary phase is difficult to be enhanced. Therefore, there is a concern that the atomic concentration of Dy contained in the second grain boundary phase becomes inadequate. On the other hand, when the oxygen atomic concentration of the second grain boundary phase based on the combined total of atomic concentration of rare earth elements is more than the above-mentioned range, the elements such as Fe other than rare earth elements are oxidized to reduce coercivity (Hcj).

Further, a preferable composition of the R-T-B-based magnet of the present invention is one where R is contained at 27 to 33% by mass or more preferably 30 to 32% by mass, B is contained at 0.85 to 1.3% by mass or more preferably 0.87 to 0.98% by mass, and the remnant is T and unavoidable impurities.

The level of coercivity may become insufficient in some cases if R constituting the R-T-B-based magnet is less than 27% by mass, and remanence may become insufficient in some cases if R exceeds 33% by mass.

In addition, R of the R-T-B-based magnet preferably contains Nd serving as the primary component thereof. An example of rare earth elements contained in R of the R-T-B-based magnet other than Nd and Dy includes Sc, Y, La, Ce, Pr, Pm, Sm, Eu, Gd, Tb, Ho, Er, Tm, Yb and Lu. Of these, Pr and Tb are particularly desirable.

The Dy atomic concentration within the R-T-B-based magnet is preferably 2 to 17% by mass, more preferably 2 to 15% by mass and still more preferably 4 to 10% by mass. When the Dy atomic concentration within the R-T-B-based magnet exceeds 17% by mass, remanence (Br) is remarkably reduced. On the other hand, when the Dy atomic concentration within the R-T-B-based magnet is less than 2% by mass, coercivity of the R-T-B-based magnet may be insufficient for motor applications.

T contained in the R-T-B-based magnet denotes a metal that essentially contains Fe, and other than Fe, it may contain a transition metal such as Co and Ni. If Co is contained other than Fe, it is preferable because the Tc (Curie temperature) can be improved.

Further, B contained in the R-T-B-based magnet is preferably 0.85 to 1.3% by mass. When B constituting the R-T-B-based magnet is less than 0.85% by mass, coercivity of the R-T-B-based magnet may be insufficient. On the other hand, when B is more than 1.3% by mass, remanence (Br) may be remarkably reduced.

B contained in the R-T-B-based magnet denotes boron, however, a part thereof may be substituted either with C or N.

Further, in order to improve the coercivity, the R-T-B-based magnet preferably contains Al, Cu, and Ga.

Ga is to be contained preferably at 0.03% by mass to 0.3% by mass. If Ga is contained at 0.03% by mass or more, the coercivity can be effectively improved. However, it is not preferable if the Ga content exceeds 0.3% by mass, because remanence is reduced.

Al is to be contained preferably at 0.01% by mass to 0.5% by mass. If Al is contained at 0.01% by mass or more, the coercivity can be effectively improved. However, it is not preferable if the Al content exceeds 0.5% by mass, because remanence is reduced.

Furthermore, the oxygen concentration of the R-T-B-based magnet is preferably as low as possible. The oxygen concentration is preferably 0.5% by mass or less, and more preferably 0.2% by mass or less. When the oxygen content is 0.5% by mass or less, a sufficient level of magnetic characteristic for an application to a motor can be achieved. When the oxygen content exceeds 0.5% by mass, there is a possibility that the magnetic characteristic may be significantly reduced.

Moreover, the carbon concentration of the R-T-B-based magnet is preferably as low as possible. The carbon concentration is preferably 0.5% by mass or less, and more preferably 0.2% by mass or less. When the carbon content is 0.5% by mass or less, a sufficient level of magnetic characteristic for an application to a motor can be achieved. If the carbon content exceeds 0.5% by mass, then there will be a possibility that the magnetic characteristic may be significantly reduced.

Next, a method for manufacturing the R-T-B-based magnet of the present invention is described. Examples of the method for manufacturing the R-T-B-based magnet of the present invention include a method in which raw materials containing an alloy material for the permanent magnet are pressed, sintered, followed by heat-treated.

As the alloy material for the permanent magnet used in manufacturing the R-T-B-based magnet of the present invention, an alloy material having a composition corresponding to a composition of the R-T-B-based magnet, and including an R-T-B-based alloy and a metal powder is preferably used. When the alloy material including an R-T-B-based alloy and a metal powder is used as the alloy material for the permanent magnet, the alloy material is pressed and followed by sintered to readily obtain an R-T-B-based magnet in which a grain boundary phase includes a first grain boundary phase and a second grain boundary phase having different atomic concentration of Dy to each other.

Moreover, the alloy material for the permanent magnet is preferably a mixed material of a powder composed of an R-T-B-based alloy and a metal powder. When the alloy material for the permanent magnet is the mixed material of a powder composed of an R-T-B-based alloy and a metal powder, an alloy material for the permanent magnet having uniform quality can readily be obtained by only mixing a powder of an R-T-B-based alloy and a metal powder. In addition, by pressing the alloy material for the permanent magnet, followed by sintering, an R-T-B-based magnet having uniform quality can readily be obtained.

It is preferable that R denote one member, or two or more members selected from rare earth elements within the R-T-B-based alloy contained in the alloy material for the permanent magnet, and Dy be contained at 2 to 17% by mass in the R-T-B-based alloy.

The average grain size (d50) of the powder composed of the R-T-B-based alloy is preferably 3 to 4.5 μm. Further, the preferred average grain size (d50) of the metal powder is in a range of 0.01 to 300 μm.

Further, as the metal powder contained in the alloy material for the permanent magnet, a powder such as Al, Si, Ti, Ni, W, Zr, TiAl alloy, Cu, Mo, Co, Fe and Ta can be used. The metal powder is not particularly limited, but preferably contains a powder of any one of Al, Si, Ti, Ni, W, Zr, TiAl alloy, Co, Fe and Ta, and more preferably a powder of any one of Fe, Ta and W.

The metal powder is preferably contained at 0.002 to 6% by mass within the alloy material for the permanent magnet, more preferably at 0.01 to 4% by mass, and still more preferably at 0.5 to 2% by mass. When the content of the metal powder is less than 0.002% by mass, the grain boundary phase of the R-T-B-based magnet is not configured to include a first grain boundary phase and a second grain boundary phase having different atomic concentration of Dy to each other. As a result, coercivity (Hcj) of the R-T-B-based magnet may not be sufficiently improved. On the other hand, it is not preferable if the content of the metal powder exceeds 6% by mass, because the magnetic properties of the R-T-B-based magnet such as remanence (Br) and maximum energy product (BHmax) are significantly reduced.

The alloy material for the permanent magnet used in manufacturing the R-T-B-based magnet of the present invention may be produced by mixing an R-T-B-based alloy and a metal powder, although it is preferable to be produced by mixing a powder composed of an R-T-B-based alloy and a metal powder.

The powder composed of the R-T-B-based alloy may be obtained, for example, by a method in which a molten alloy melt is cast by means of an SC (strip casting) method to manufacture a cast alloy thin strip, the obtained cast alloy thin strip is then crushed, for example, by means of a hydrogen decrepitation method, and it is then pulverized using a pulverizer.

Examples of the hydrogen decrepitation method include a method in which after having absorbed hydrogen in a cast alloy thin strip at room temperature and heat-treated it at a temperature of approximately 300° C., hydrogen is degassed by depressurization, and then it is heat-treated at a temperature of approximately 500° C. to thereby remove the hydrogen in the cast alloy thin strip. In the hydrogen decrepitation method, the cast alloy thin strip having absorbed hydrogen expands in volume, and consequently a number of cracks are generated in the cast alloy therein and the cast iron strip is thereby crushed.

Moreover, examples of the method of pulverizing the hydrogen decrepitated cast alloy thin strip include a method in which on a pulverizer such as a jet mill, the hydrogen decrepitated cast alloy thin strip is fine-pulverized to an average grain size of 3 to 4.5 μm using highly pressurized nitrogen at 0.6 MPa, to thereby prepare it in a powder form.

Examples of a method of manufacturing an R-T-B-based magnet with use of an alloy material for the permanent magnet obtained in this way include a method in which raw material, in which 0.02 to 0.003% by mass of zinc stearate is added as a lubricating agent to the alloy material for the permanent magnet, is pressed using a pressing machine while applying a transverse magnetic field and is sintered in a vacuum at 1,030 to 1,080° C., and is then heat-treated at 400 to 800° C.

A case of manufacturing an R-T-B-based alloy using an SC method was described in the examples above, however, the R-T-B-based alloy used in the present invention is not to be considered limited to one that is manufactured using an SC method. For example, an R-T-B-based alloy may also be cast by means of a centrifugal casting method, a book pressing method, and the like.

Moreover, the R-T-B-based alloy and the metal powder, as described above, may be mixed after having cracked a cast alloy thin strip and prepared it as a powder composed of the R-T-B-based alloy. However, for example, the cast alloy thin strip and the metal powder may be mixed to thereby prepare it as an alloy material for the permanent magnet before cracking the cast alloy thin strip, and then the alloy material for the permanent magnet that contains the cast alloy thin strip may be cracked. In this case, it is preferable that the alloy material for the permanent magnet composed of the cast alloy thin strip and the metal powder be cracked in a manner similar to the method of cracking the cast alloy thin strip, and then it be pressed and sintered in a manner similar to that described above, to thereby manufacture an R-T-B-based magnet.

Moreover, mixing of the R-T-B-based alloy and the metal powder may be conducted after having added a lubricating agent such as zinc stearate to the powder composed of the R-T-B-based alloy.

The metal powder in the alloy material for the permanent magnet of the present invention may be finely and uniformly distributed. However, it may not need to be finely and uniformly distributed, and for example, the grain size thereof may be 1 μm or greater, or it may be aggregated in a size of 5 μm or greater for achieving the effect. Further, the higher the Dy concentration is, the higher the effects of improving coercivity due to a metal powder being contained in an alloy material for the permanent magnet. Furthermore, if Ga is contained therein, the effects are significantly exhibited.

The R-T-B-based magnet of the present embodiment is configured so that the grain boundary phase includes a first grain boundary phase and a second grain boundary phase which have different atomic concentration of Dy to each other, the Dy atomic concentration of the first grain boundary phase being less than that of the main phase, and the Dy atomic concentration of the second grain boundary phase being more than that of the main phase. Therefore, the R-T-B-based magnet of the present embodiment has a high level of coercivity (Hcj) and also becomes suitable as a magnet for a motor having a sufficiently high level of remanence (Br).

It is preferable that the coercivity (Hcj) of the R-T-B-based magnet be as high as possible, although it is preferably 30 kOe or more in those cases where it is used as a magnet for a motor. If the coercivity (Hcj) in a magnet for a motor is less than 30 kOe, the heat tolerance thereof for a motor may become insufficient in some cases.

Further, it is also preferable that the remanence (Br) of the R-T-B-based magnet be as high as possible, although it is preferably 10.5 kG or more in those cases where it is used as a magnet for a motor. It is not preferable for a magnet in a motor if the remanence (Br) of the R-T-B-based magnet is less than 10.5 kG, because the torque of the motor may be insufficient.

In the R-T-B-based magnet of the present embodiment, it is possible to obtain a sufficiently high level of coercivity (Hcj) without increasing the Dy concentration within the R-T-B-based alloy. Hence, the R-T-B-based magnet of the present embodiment has excellent magnetic properties to be suitably used for a motor, an automobile, a power generator, a wind power-generating apparatus, or the like.

### EXAMPLES

### “Experimental Examples 1 to 4”

An Nd metal (purity 99 wt % or greater), Pr metal (purity 99 wt % or greater), Dy metal (purity 99 wt % or greater), ferroboron (Fe 80 wt %, B 20 wt %), Al metal (purity 99 wt % or greater), Co metal (purity 99 wt % or greater), Cu metal (purity 99 wt % or greater), Ga metal (purity 99 wt % or greater), and iron mass (purity 99 wt % or greater) were weighed so as to correspond to the component composition of an alloy A shown in Table 1, and were charged into an alumina crucible.

TABLE 1

| | Thickness | Component (wt %) | | | | | | | | | | | Average grain |
|---|---|---|---|---|---|---|---|---|---|---|---|---|---|
| | (mm) | Nd | Pr | Dy | B | Al | Co | Cu | Ga | C | O | Fe | size d50 (μm) |
| Alloy A | 0.29 | 17.0 | 6.0 | 9.5 | 0.9 | 0.1 | 1.0 | 0.1 | 0.08 | 0.012 | 0.013 | Balance | 4.5 |
| Alloy B | 0.30 | 20.0 | 6.0 | 4.5 | 0.9 | 0.1 | 1.0 | 0.1 | 0.08 | 0.012 | 0.013 | Balance | 4.5 |
| Alloy C | 0.30 | 24.5 | 6.0 | 0.0 | 0.9 | 0.1 | 1.0 | 0.1 | 0.08 | 0.012 | 0.013 | Balance | 4.5 |

Then, the inside of the furnace of a high frequency vacuum induction furnace where the alumina crucible was placed was substituted with Ar. Having heated to 1,450° C. to melt, the melt thereof was poured on a water-cooled copper roll, and an SC (strip casting) method was performed at a peripheral speed of 1.0 m/second so as to have an average thickness of approximately 0.3 mm, a distance between R-rich phases of 3 to 15 μm, and a volume ratio of a phase (the main phase) other than the R-rich phases≧(138-1.6r) (wherein r is the content of rare earths (Nd, Pr, Dy)), to thereby obtain a cast alloy thin strip.

The distance between R-rich phases and the volume ratio of the main phase of the cast alloy thin strip thus obtained were examined by the following methods. That is, the cast alloy thin strip having a thickness within an average thickness±10% was embedded in a resin and, after polishing, a backscattered electron image was photographed by a scanning electron microscope (JEOL ISM-5310). Using the obtained 300 times magnification micrograph, the distance between R-rich phases was measured and also the volume ratio of the main phase was calculated. As a result, the distance between R-rich phases of an alloy A shown in Table 1 was from 4 to 5 μm, and the volume ratio of the main phase was from 90 to 95%.

Next, the cast alloy thin strip was then crushed by means of a hydrogen decrepitation method described below. First, the cast alloy thin strip was coarse-crushed so that the diameter thereof became approximately 5 mm, and it was then inserted into a hydrogen atmosphere at room temperature to thereby have hydrogen absorbed therein. Subsequently, heat treatment was performed in which the cast alloy thin strip that had been coarse-crushed and had occluded hydrogen therein was heated to 300° C. Then, cracking was performed by a method in which hydrogen was degassed by depressurization, heat treatment was performed to further heat it to 500° C. to thereby have hydrogen in the cast alloy thin strip released and removed, and then it was cooled to room temperature.

Next, 0.025 wt % of zinc stearate was added as a lubricating agent to the cracked cast alloy thin strip, and on a jet mill (Hosokawa Micron 100AFG), the hydrocracked cast alloy thin strip was fine-pulverized into powder at an average grain size of 4.5 μm, using highly pressurized nitrogen at 0.6 MPa.

A metal powder having the average grain size shown in Table 2 was added to and mixed with the powder (alloy A) composed of the R-T-B-based alloy having the average grain size shown in Table 1 obtained in this way, according to the proportion (concentration (% by mass) of the metal powder contained in the alloy material for the permanent magnet) shown in Table 3, to thereby manufacture the alloy material for the permanent magnet. The grain size of the metal powder was measured using a laser diffraction meter.

TABLE 2

| Metal powder | Average grain size d50 (μm) |
|---|---|
| W | 6.5 |
| Ta | 11.5 |
| Fe | 6.2 |

TABLE 3

| Experi- | | | Additive | | | | |
|---|---|---|---|---|---|---|---|
| mental | | Metal | amount | Hcj | Br | SR | Bhmax |
| Example | Alloy | powder | (wt %) | (kOe) | (kG) | (%) | (MGOe) |
| 1 | A | W | 1.0 | 35.4 | 11.4 | 89.9 | 31.9 |
| 2 | A | Ta | 1.0 | 34.0 | 11.5 | 90.7 | 32.7 |
| 3 | A | Fe | 2.0 | 34.1 | 11.7 | 90.7 | 33.8 |
| 4 | A | None | 0.0 | 29.8 | 11.7 | 90.8 | 33.2 |
| 5 | B | W | 0.6 | 23.6 | 13.0 | 94.5 | 41.1 |
| 6 | B | Ta | 1.8 | 24.0 | 12.8 | 94.4 | 39.7 |
| 7 | B | Fe | 1.0 | 23.1 | 13.0 | 95.1 | 41.1 |
| 8 | B | None | 0.0 | 22.5 | 13.1 | 94.7 | 41.5 |
| 9 | C | W | 2.0 | 14.0 | 13.3 | 91.9 | 41.3 |
| 10 | C | Ta | 1.0 | 15.0 | 13.7 | 95.4 | 45.3 |
| 11 | C | Fe | 4.0 | 11.2 | 13.8 | 93.2 | 43.7 |
| 12 | C | None | 0.0 | 14.6 | 14.2 | 95.6 | 48.3 |

Next, the alloy material for the permanent magnet obtained in this way was pressed at a pressing pressure 0.8 t/cm², using a pressing machine applying transverse magnetic field, to thereby prepare a powder compact. Then, the obtained powder compact was sintered in a vacuum. The powder compact was sintered at a temperature of 1,080° C. Then, the powder compact was heat-treated at 500° C., and was then cooled, to thereby manufacture the R-T-B-based magnets of Experimental Example 1 to Experimental Example 4.

By using a BH curve tracer (Toei Kogyo TPM2-10), the magnetic properties of the respective R-T-B-based magnets of Experimental Example 1 to Experimental Example 4 that were obtained with use of the alloy material for the permanent magnet containing a metal powder and the alloy material for the permanent magnet not containing the metal powder were measured. The results of this are shown in Table 3.

In Table 3, “Hcj” represents coercivity, “Br” represents remanence, “SR” represents squareness, and “BHmax” represents maximum energy product. Moreover, these values of magnetic properties are the average values of the measured values of the respective five R-T-B-based magnets.

Further, a backscattered electron image of the R-T-B-based magnet according to Experimental Examples 1 to 4 was projected using FE-EPMA (Electron Probe Micro Analyzer). The main phase and the grain boundary phase of R-T-B-based magnet were discriminated based on the contrast of the backscattered electron image. Thereafter, the composition of the main phase and the grain boundary phase was investigated with a point analysis using WDX (wavelength dispersive X-ray spectrometry apparatus), thereby calculating the compositional ratio thereof. The results of this are shown in Table 4.

TABLE 4
Composition of each phase of alloy A sintered magnet

Unit: at %

| Experimental | | | | | | Combined | | | | | |
|---|---|---|---|---|---|---|---|---|---|---|---|
| Example | | | Nd | Pr | Dy | total of R | Fe | B | C | O | The others |
| 1 | W 1.0 wt % | Main phase | 6.4 | 1.7 | 3.6 | 11.7 | 76.9 | 5.0 | 0.1 | 2.1 | 4.2 |
| | | First grain boundary phase | 37.4 | 16.1 | 1.6 | 55.1 | 15.6 | 0.0 | 7.3 | 5.6 | 16.4 |
| | | Second grain boundary phase | 20.1 | 5.8 | 8.2 | 34.1 | 5.4 | 0.0 | 16.2 | 44.3 | 0.0 |
| 2 | Ta 1.0 wt % | Main phase | 6.5 | 1.8 | 3.5 | 11.8 | 77.7 | 5.0 | 0.1 | 2.1 | 3.3 |
| | | First grain boundary phase | 34.5 | 14.8 | 2.1 | 51.4 | 27.1 | 0.0 | 4.8 | 5.0 | 11.7 |
| | | Second grain boundary phase | 19.9 | 5.8 | 8.1 | 33.8 | 7.5 | 0.0 | 14.4 | 44.3 | 0.0 |
| 3 | Fe 2.0 wt % | Main phase | 6.4 | 1.7 | 3.5 | 11.6 | 76.9 | 4.8 | 0.8 | 3.4 | 2.5 |
| | | First grain boundary phase | 36.1 | 16.5 | 1.4 | 54.0 | 17.3 | 0.0 | 4.1 | 8.3 | 16.3 |
| | | Second grain boundary phase | 20.3 | 6.2 | 7.1 | 33.6 | 3.0 | 0.0 | 14.6 | 48.8 | 0.0 |
| 4 | No additives | Main phase | 6.5 | 1.8 | 3.5 | 11.8 | 77.4 | 4.7 | 0.3 | 3.3 | 2.5 |
| | | First grain boundary phase | 40.3 | 17.6 | 1.0 | 58.9 | 12.7 | 0.0 | 4.4 | 6.6 | 17.4 |

### “Experimental Examples 5 to 12”

Each component was weighed so as to correspond to the component composition of an alloy B or C shown in Table 1, thereby manufacturing the powder (the alloy B or C) composed of the R-T-B-based alloy having an average grain size shown in Table 1 in the same procedure as Experimental Examples 1 to 4. Next, the metal powders having the grain size shown in Table 2 were added to the alloy B or C at the proportion shown in Table 3, and they were mixed, thereby manufacturing the alloy material for the permanent magnets. These alloy materials for the permanent magnet were pressed, sintered in the same procedure as Experimental Examples 1 to 4, to thereby manufacture the R-T-B-based magnets of Experimental Examples 5 to 12. Thereafter, magnetic properties and a compositional ratio of each phase were measured in the same manner as Experimental Examples 1 to 4.

The results of this are shown in Tables 5 and 6. Since the alloy C contained no Dy, R-T-B-based magnets manufactured from the alloy C may not contain a second grain boundary phase. However, in the Experimental Examples 9 to 11, a phase having a composition different from that of the first grain boundary phase was observed. Hence, for the sake of simplicity, the phase was described in Table 6 as a second grain boundary phase.

TABLE 5
Composition of each phase of alloy B sintered magnet

Unit: at %

| Experimental | | | | | | Combined | | | | | |
|---|---|---|---|---|---|---|---|---|---|---|---|
| Example | | | Nd | Pr | Dy | total of R | Fe | B | C | O | The others |
| 5 | W 0.6 wt % | Main phase | 8.0 | 2.2 | 1.7 | 11.9 | 77.9 | 4.7 | 0.7 | 2.2 | 2.6 |
| | | First grain boundary phase | 41.9 | 20.1 | 0.6 | 62.6 | 19.6 | 0.0 | 4.8 | 6.8 | 6.2 |
| | | Second grain boundary phase | 23.1 | 7.2 | 2.8 | 33.1 | 3.7 | 0.0 | 13.3 | 49.9 | 0.0 |
| 6 | Ta 1.8 wt % | Main phase | 8.6 | 2.5 | 1.7 | 12.8 | 77.4 | 4.7 | 0.2 | 2.1 | 2.8 |
| | | First grain boundary phase | 40.9 | 17.6 | 1.0 | 59.5 | 11.5 | 0.0 | 3.9 | 11.1 | 14.0 |
| | | Second grain boundary phase | 23.6 | 7.3 | 2.8 | 33.7 | 3.3 | 0.0 | 13.7 | 49.1 | 0.2 |
| 7 | Fe 1.0 wt % | Main phase | 8.0 | 2.2 | 1.7 | 11.9 | 78.6 | 4.7 | 0.2 | 1.9 | 2.7 |
| | | First grain boundary phase | 41.4 | 20.3 | 0.5 | 62.2 | 20.9 | 0.0 | 4.6 | 9.8 | 2.5 |
| | | Second grain boundary phase | 24.3 | 7.4 | 3.0 | 34.7 | 3.1 | 0.0 | 15.1 | 47.1 | 0.0 |
| 8 | No additives | Main phase | 8.0 | 2.2 | 1.7 | 11.9 | 77.5 | 4.8 | 0.4 | 2.8 | 2.6 |
| | | First grain boundary phase | 41.9 | 21.0 | 0.3 | 63.3 | 8.8 | 0.0 | 8.1 | 19.3 | 0.5 |

TABLE 6
Composition of each phase of alloy C sintered magnet

Unit: at %

| Experimental | | | | | | Combined | | | | | The |
|---|---|---|---|---|---|---|---|---|---|---|---|
| Example | | | Nd | Pr | Dy | total of R | Fe | B | C | O | others |
| 9 | W 2.0 wt % | Main phase | 9.4 | 2.5 | 0.0 | 11.9 | 77.5 | 4.7 | 0.7 | 2.6 | 2.6 |
| | | First grain boundary phase | 40.7 | 17.8 | 0.0 | 58.5 | 15.0 | 0.0 | 3.8 | 5.9 | 16.8 |
| | | Second grain boundary phase | 26.8 | 8.2 | 0.0 | 35.0 | 3.1 | 0.0 | 12.9 | 49.0 | 0.0 |
| 10 | Ta 1.0 wt % | Main phase | 9.5 | 2.6 | 0.0 | 12.1 | 78.7 | 4.9 | 0.3 | 1.3 | 2.7 |
| | | First grain boundary phase | 37.9 | 17.4 | 0.0 | 55.3 | 16.2 | 0.0 | 5.0 | 7.4 | 16.1 |
| | | Second grain boundary phase | 29.2 | 8.8 | 0.0 | 38.0 | 2.7 | 0.0 | 18.1 | 41.2 | 0.0 |
| 11 | Fe 4.0 wt % | Main phase | 9.3 | 2.5 | 0.0 | 11.8 | 78.2 | 5.4 | 0.2 | 1.8 | 2.6 |
| | | First grain boundary phase | 34.5 | 15.6 | 0.0 | 50.1 | 23.2 | 0.0 | 3.5 | 9.3 | 13.9 |
| | | Second grain boundary phase | 24.8 | 8.1 | 0.0 | 32.9 | 3.7 | 0.0 | 14.0 | 49.4 | 0.0 |
| 12 | No additives | Main phase | 9.2 | 2.5 | 0.0 | 11.7 | 77.3 | 4.8 | 0.4 | 3.1 | 2.7 |
| | | First grain boundary phase | 37.1 | 16.1 | 0.0 | 53.2 | 16.1 | 0.0 | 4.3 | 11.3 | 15.1 |

As shown in Tables 3 to 5, R-T-B-based magnets according to Experimental Examples 1 to 3 and Experimental Examples 5 to 7 where the grain boundary phase included the first grain boundary phase and the second grain boundary phase having a different average atomic weight to each other has a high level of coercivity (Hcj) as compared to R-T-B-based magnets according to Experimental Examples 4 and 8 where the grain boundary phase is only a single phase. Accordingly, it was found that when the grain boundary phase includes the first grain boundary phase and the second grain boundary phase, coercivity can be enhanced without increasing the additive amount of Dy.

Further, since the alloy C does not contain Dy, R-T-B-based magnets of Experimental Examples 9 to 11 contain no second grain boundary phase. Therefore, as shown in Table 3, R-T-B-based magnets of Experimental Examples 9 to 11 do not exhibit enhanced coercivity as compared to R-T-B-based magnet of Experimental Example 12.

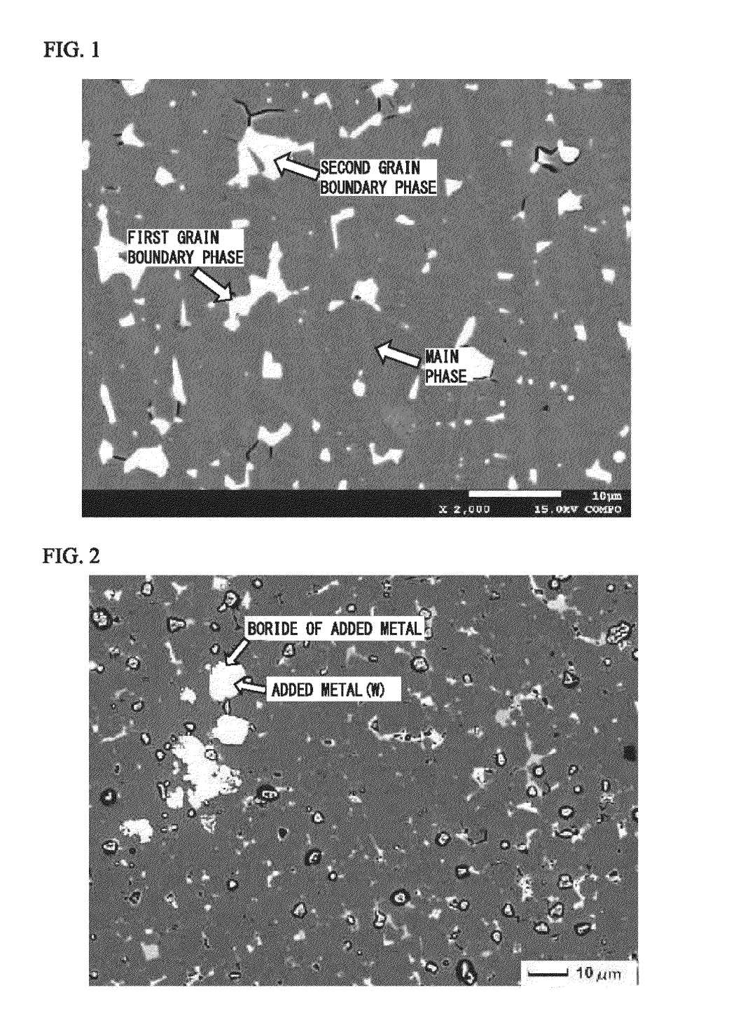

FIG. 1 is a micrograph of the R-T-B-based magnet according to Experimental Example 3, which is an example of the R-T-B-based rare earth permanent magnet according to the present invention. In the micrograph (backscattered electron image of FE-EPMA) of the R-T-B-based magnet shown in FIG. 1, a part colored with Oxford gray is a main phase, and a part colored with light gray is a grain boundary phase. In the R-T-B-based magnet shown in FIG. 1, it was found that the grain boundary phase included a first grain boundary phase (a part colored with verge on white within the part colored with light gray of FIG. 1) and a second grain boundary phase (a part colored with verge on black within the part colored with light gray of FIG. 1) which have different atomic concentration of Dy to each other.

The backscattered electron image was photographed with 2,000 times magnification at 15 kV accelerating voltage.

FIG. 2 is a micrograph of the R-T-B-based magnet according to Experimental Example 1, which is an example of the R-T-B-based rare earth permanent magnet according to the present invention. In the micrograph (backscattered electron image of FE-EPMA) of the R-T-B-based magnet shown in FIG. 2, a part colored with Oxford gray is a main phase. In the R-T-B-based magnet shown in FIG. 2, it was found that a boride of W (a part colored with verge on black within the part colored with light gray of FIG. 2) was deposited around W (a part colored with verge on white within the part colored with light gray of FIG. 2), which is a metal powder.

The backscattered electron image was photographed with 1,000 times magnification at 15 kV accelerating voltage.

### INDUSTRIAL APPLICABILITY

An R-T-B-based rare earth permanent magnet of the present invention includes a sintered body which is provided with a main phase mainly containing R₂Fe₁₄B, and with a grain boundary phase which has a greater R content than said main phase, wherein R denotes a rare earth element including Nd and Dy as an essential element, and the grain boundary phase includes a first grain boundary phase and a second grain boundary phase which have different atomic concentration of Dy to each other. Therefore, the R-T-B-based rare earth permanent magnet of the present invention can possess a grain boundary phase having high effects of improving magnetic properties, as compared to a grain boundary phase of an R-T-B-based rare earth permanent magnet containing a single grain boundary phase having the same concentration of Dy in the R-T-B-based rare earth permanent magnet. Accordingly, it is possible to obtain a sufficiently high level of coercivity (Hcj) without increasing the Dy concentration, as compared to an R-T-B-based rare earth permanent magnet containing a single grain boundary phase having the same Dy concentration. Furthermore, it is possible to suppress the decrease of magnetic properties such as remanence (Br) due to the addition of Dy. Thus, it is possible to realize an R-T-B-based rare earth permanent magnet having excellent magnetic properties, which is suitably used for a motor, an automobile, a power generator, a wind power-generating apparatus, or the like. Therefore, the R-T-B-based rare earth permanent magnet of the present invention is extremely useful industrially.

1. An R-T-B-based rare earth permanent magnet comprising a sintered body which is provided with a main phase mainly containing R₂Fe₁₄B, and with a grain boundary phase which has a greater R content than said main phase, wherein
R denotes a rare earth element including Nd and Dy as an essential element, and
the grain boundary phase includes a first grain boundary phase and a second grain boundary phase which have different atomic concentration of Dy to each other.

2. The R-T-B-based rare earth permanent magnet according to claim 1, wherein the Dy atomic concentration of the first grain boundary phase is less than that of the main phase, and
the Dy atomic concentration of the second grain boundary phase is more than that of the main phase.

3. The R-T-B-based rare earth permanent magnet according to claim 2, wherein the Dy atomic concentration of the second grain boundary phase is 1.5 to 3 times that of the main phase.

4. The R-T-B-based rare earth permanent magnet according to claim 2, wherein the Dy atomic concentration of the second grain boundary phase is two to six times that of the first grain boundary phase.

5. The R-T-B-based rare earth permanent magnet according to claim 2, wherein the second grain boundary phase has the Dy atomic concentration of 2 to 9 at %.

6. The R-T-B-based rare earth permanent magnet according to claim 2, wherein the combined total of atomic concentration of rare earth elements contained in the second grain boundary phase is less than that in the first grain boundary phase.

7. The R-T-B-based rare earth permanent magnet according to claim 2, wherein the combined total of atomic concentration of rare earth elements contained in the second grain boundary phase is 30 to 40 at %.

8. The R-T-B-based rare earth permanent magnet according to claim 2, wherein an oxygen atomic concentration of the second grain boundary phase is higher than that of the main phase or that of the first grain boundary phase.

9. The R-T-B-based rare earth permanent magnet according to claim 2, wherein the oxygen atomic concentration of the second grain boundary phase is 1.3 to 1.5 times the combined total of atomic concentration of rare earth element.

10. A motor provided with the R-T-B-based rare earth permanent magnet according to claim 1.

11. An automobile provided with the motor according to claim 10.

12. A power generator provided with the R-T-B-based rare earth permanent magnet according to claim 1.

13. A wind power-generating apparatus provided with the power generator according to claim 12.
